(19) United States
(12) Patent Application Publication
(10) Pub. No.: US 2024/0303723 A1
(43) Pub. Date: Sep. 12, 2024

(54) METHOD AND SYSTEM FOR SEALED BID AUCTIONS

(71) Applicant: BYNFOR, INC., Flushing, NY (US)

(72) Inventor: Kevin Sunlin Wang, Flushing, NY (US)

(73) Assignee: BYNFOR, INC., Flushing, NY (US)

(21) Appl. No.: 18/666,810

(22) Filed: May 17, 2024

Related U.S. Application Data
(63) Continuation of application No. 14/967,301, filed on Dec. 12, 2015.
(60) Provisional application No. 62/246,987, filed on Oct. 27, 2015.

(51) Int. Cl. G06Q 30/08

(52) U.S. Cl. CPC G06Q 30/08

(57) ABSTRACT

Disclosed herein is system and method for sealed bid auctions through the implementation of computer device, wherein an auction includes sealed bids, assigning random IDs for undisclosed real IDs, and obtaining double confirmation from both bidders and vendors. Vendors may choose to have a reserve price such as an open reserve price and a conditional hidden reserve price. The system generates random bidder IDs and allows the bidders to self-determine into two different bidding categories, where one bidding category pays the full winning bid amount and the other bidding category purchases a “price-protection policy” that allows the recalculation of the final winning bid amount based on the “price-protection formula”, wherein the “price-protection formula” is calculated as a sum of the “price-protection fee”, the second-highest bid amount, and the amount from a pre-determined percentage of a difference between the highest bid amount and a second-highest bid amount.

### CROSS-REFERENCE TO RELATED APPLICATION

This application is a Continuation of U.S. Nonprovisional application Ser. No. 14/967,301, filed on Dec. 12, 2015 which claims priority to U.S. Provisional Application No. 62/246,987, filed on Oct. 27, 2015, the entire contents of all applications which are herein incorporated by reference.

### FIELD OF THE INVENTION

The present disclosure relates to auctions and, more specifically, to a method and system for sealed bidding in online auctions. The method allows for vendors to either transfer ownership rights or share possession rights for the auctioned subject, wherein the auctioned subject may be tangible or intangible and include anything that may have a value for example, goods, skills, services, space, or financial resources, etc. It can be used on broad spectrum of electronic devices, including but not limited to computers, mobile device and tablets, etc. In addition, the method disclosed herein may be applied in live auctions.

### BACKGROUND

Traditional auctions are a form of negotiating the price of scarce resources and selling such resources at an optimal price accepted by buyer and seller. The goal of an auction is to optimize the revenue of the seller and minimize the cost of the buyer. Traditional auctions are known from ancient Greeks and were first mentioned around 500 B.C. American auctions date back to the 1600s and were popular after the Pilgrims' arrival on America's Eastern Shores during colonization due to an inherent profitability from the sale of crops, imports, livestock, tools, tobacco, and entire farms, etc. Selling at auction was a quick and efficient way to convert currently existing assets into cash. Since then, auctions have gone through different cycles and have continued to evolve. In the late 1900s, specifically the 1990s, technology was beginning to establish itself in the auction business which further developed to accommodate the usage of developing technology where auctioneers began to use computers, fax machines, cell phones and other technology to make their businesses run faster and more efficiently.

Due to these technological developments, auctioneers today are capable of offering both live and online auctions to meet the distinct needs of customers both near and far. Nowadays, technology allows buyers to participate in the sale without the need to be physically present at the auction. Online auctions are popular as the internet provides a user-friendly, convenient platform for the exchange of properties of value between the interested parties. Online auctions can be conducted through mobile applications and websites, which is accessible to anyone who has an internet connection.

Based on existing prior art and auction practices, there are open and sealed-bid auctions. Open auctions are such where bids are broadcast to all participants. Open auctions may be of ascending-bid (English) or descending-bid (Dutch) model. In an ascending-bid auction model properties of value are offered up for bidding, and the winner is the last bidder that offers the highest price after a certain amount of time. The descending-bid auction is an auction model where the property of value begins at a higher asking price, which is lowered by the auctioneer until the bidder accepts. One of the major advantages of the open auctions is that the bidders see each other's bids, which makes the auction transparent. However, there are many negative impacts associated with transparency for disclosing the bid amounts in open auctions.

While popular and successful, online auctions are not without shortfalls and deficiencies. For example, fairness is a big issue in open auctions. Deficiencies of the open auctions that accompany online open auctions may include but are not limited to “bid shielding”, “bid shading”, “shill bidding”, “bid sniping”, and “collusion”, etc. in which indecent bidders may be involved. Such deficiencies may occur because bid amounts are open and can be easily manipulated by indecent bidders who abuse auction procedures by being involved in the above indecent or illegal activities.

“Bid shielding” occurs when a high value bid is withdrawn at the last minute of the auction to allow a lower bid to be accepted. “Bid shilling” introduces the tactics of artificially high bids in order to increase the price to force the bona fide bidders to pay more for the properties they want to buy. “Bid shading” occurs when the bidder knowingly places a bid that is below or above what they believe the auctioned property is actually worth. The purpose of shading is to mislead other bidders on the actual price of the item.

“Bid sniping” is last minute bidding with the intent of preventing other bidders from responding and outbidding the price. Software is apparently available to aid in the practice. This applies mainly on sites which have a fixed bid close time. “Collusion” not only occurs when there is an illegal cooperation between the buyers who decide to agree to not bid against each other, allowing the price to stay low, but also occurs between vendors who bid on each other's items to falsely increase prices the winning buyer will pay. “Collusion” may lead to “bid shielding”, “shill bidding” and/or “bid shading”, etc. which occurs frequently in open auctions.

In order to win the open bid ascending online auction with all these inherent deficiencies, bona fide bidders often times have to closely monitor the auction to make sure they won't get outbid, especially in the last seconds of the auction. The entire auction procedure becomes very time consuming and psychologically stressful if the bona fide bidder is outbid in the last seconds of the auction due to another bidder's “bid sniping.” Bidders often find themselves frustrated at the time efforts they must put, in which they still fail because of “bid sniping”.

Indecent bidders are hard to detect on the Internet because from the appearance alone it is not easy to identify the difference between indecent and bona fide bidders. For example, all online auction systems have a fixed bid close time, “bid sniping” may occur within any open bid system and a bidder can legally bid anytime between the first second through the last second of the auction. It is almost impossible to identify who is a bona fide bidder and who is an indecent bidder if the “bid sniping” occurs in the last second of the auction. Many open auction online websites claim to have measures to detect and remove the indecent abusers. Although there are measures in place to prevent fraudulent or unfair activities in online auctions, currently available systems and methods are not effective. For example, user-reporting suspicious bidding activity are too slow and involve too many variables to create favorable results for bona fide bidders. User-reporting measures involve investigations which may take more time than can be afforded for the bidders as an auction may end before the issues are resolved. Additionally, too many variables are considered when determining if a user is abusing the system. Furthermore, bona fide bidders may not have enough evidence to show another user is cheating. Even with laws that impose fines or even jail time for illegal or fraudulent bidding, the anonymity provided by the internet allows a massive amount of fraudulent activities to still take place. Since open auctions have many deficiencies mainly because of publicly visible bid amounts, one of the ways to overcome these deficiencies is through a sealed bid auction where bid amounts are not disclosed during the time of the sealed bid auction. This means that in sealed-bid auctions, bidders place their bids in the first phase of the auction but the bid value remains closed and invisible to other bidders until they are opened in the second phase.

Sealed-bid auctions may vary depending on what winning price is paid for the item and there are sealed-bid first-price and sealed-bid second-price auction methods. The traditional form of sealed-bid auction is a first-price auction, where the highest bid wins the auction. In sealed-bid first-price auctions buyers may face several problems. “Winner's curse” is one of common issues not only in open bid first-price auctions but also in sealed-bid auctions. “Winner's curse” often occurs when the winning bid amount in an auction exceeds the intrinsic value of the auctioned subject. It is especially true for buyers and/or winners with limited knowledge about the auctioned properties who may overpay for items due to lack of experience and improper market valuation of the auctioned items. In order to overcome the deficiency such as the “winner's curse”, there is a second form of the sealed-bid auction known as the sealed second-price auction (Vickrey), where the winner pays not the highest winning price, but the second-highest price placed for the auctioned property. It means that the bidder placing the highest bid for the property will win the auction but will only be required to pay the second-highest price placed for an item, which is naturally lower than the highest winning bid and may potentially reflect the real value of the auctioned property. This type of auction has some attractive features, for example, lesser amount of “winner's curse”, as bidders may place their bids without being concerned about overpaying for the property.

However, sealed-bid second-price auction has an issue of the inherent deficiency, where bidders may be artificially increasing the bid without consideration of the real value of the auctioned item. Since the winning bidder only pays a second-highest bid amount, indecent bidders often use this tactic to win the auction. This may discourage bona fide bidders who bid the real perceived value of the property from participating in the auction, because it is very hard for bona fide bidders who bid realistic amounts to win against the indecent bidders who artificially inflate the price they bid.

Another shortfall of this method is remorse of the second-highest bidder, who doesn't win the auction but whose price is used as a real value of the item without any sort of reward.

In addition, the sealed-bid second-price method has inherent logical flaw, as the winner does not actually pay the price that the winner bid. Instead, the winner ends up paying the price bid by others, specifically the second-highest bid amount. And the bidder with the second-highest bid amount ends up with nothing, but will have his/her bid used as the referenced amount of payment for the winning bidder. This method is unfair to bona fide bidders who submit reasonable bid amounts because another indecent bidder may submit a bid with an artificially high amount in order to win the auction. Furthermore, bidders who submit second-highest bid amount may come to believe they are just a tool for providing reasonable prices without receiving anything in return. For example, one stamp is a collectible which currently often appears in online auction platforms. Assume there are four total bidders, and three bidders are bona fide stamp collector bidders who submit realistic bid amounts that reflect market values of $25, $30, and $35 respectively for one single stamp. If the fourth bidder submits $100 in the auction, under prior art auction method, such as SealedSecond™, not only will the fourth bidder win the auction, but the fourth bidder will also only be required to pay the second-highest bid amount of $35. This amount is significantly lower than the original $100 winning bid price. Under this prior art auction method, it is more advantageous to bid an artificially high amount that can always win an auction against a bona fide bidder and subsequently pay the second-highest price. Due to such a fatal deficiency, the sealed second-highest bid amount auction is not very popular in auction practices.

Available systems and methods in the prior art do not remedy the ongoing deficiencies. The goal of the present invention is to offer an auction platform that would offer more equal winning opportunities to bidders based on more fair bidding system and method.

### BRIEF SUMMARY OF THE INVENTION

Exemplary embodiments of the present invention may classify the users into two different categories-vendors and bidders depending on the purpose of participating in the auction. “Vendor” or “vendors” is the party of the auction that makes tangible and/or intangible auctioned subjects of value available to bidder or bidders and get paid if the auction is successful. For purposes of the present invention, the term tangible auctioned subject means any type of subject that has a physical form and monetary value. It may include but is not limited to goods, machinery, buildings, land, space, inventory, etc. The term intangible auctioned subject means something that has a monetary value which individuals, business entities, non-profit organizations and/or government agents can have ownership or possession rights which do not have a physical form but have monetary value and can transfer such rights temporarily to somebody else, such as services or skills. “Bidder” or “bidders” is the party of the auction that places bids for the auctioned subject and the winning bidder pays the vendor for the value of the auctioned subject.

According to one aspect of the present invention, a system for sealed bidding in an auction is provided, the system comprising: a server in communication with at least one of a plurality of vendors at a vendor computing device and at least one of a plurality of registered bidders at a bidder computing device through a communication network, wherein the server receives at least one auction request for at least one auctioned subject from at least one vendor computing device, the auction request having at least one description of the auctioned subject and a time duration of the auction input by at least one registered vendor into the vendor computing device and the server presents at least one auction based on at least one auction request to the plurality of registered bidders from at least one bidder computing device; at least one sealed bid received in at least one bidder computing device during the time duration of the auction and communicated to the server, wherein the at least one sealed bid includes a bid amount for the auctioned subject; a random bidder ID assigned by the server to each of the at least one sealed bids received from at least one bidder computing device during the time duration of the auction; a data record for each of the at least one sealed bids is stored in the server, the data record containing at least the random bidder ID, at least one actual bidder ID, at least one timestamp and at least one bid amount; wherein the server in communication with at least one of a plurality of registered vendors and at least one of a plurality of registered bidders through a communication network determines the winning bid at the end of the time duration of the auction according to the data record for each of the at least one sealed bids.

According to at least one aspect of the present invention, random IDs will be assigned for the registered bidders to bid and the bidders will self-determine himself/herself into two mainly different bidding categories, either as a bidding category one bidder or a bidding category two bidder. A bidding category one bidder pays the full winning bid amount and a bidding category two bidder has a chance for the recalculation of the final winning bid amount due to “price-protection policy” that they commit to pay before bidding. The recalculation is based on a “price-protection formula”, where the final winning bid amount is calculated using: a “price-protection fee”, a second-highest bid amount, and a pre-determined percentage of the difference between the winning bid and the second-highest bid amount. The method further comprises receiving at least one auction request for at least one auctioned subject in a server from at least one vendor computing device having at least a description of the auctioned subject and a time duration of the auction; presenting an auction based on the auction request to a plurality of bidder computing devices; receiving at least one sealed bid in one of the bidder computing devices during the time duration of the auction and communicating each sealed bid to the server, wherein the at least one sealed bid includes a bid amount for the auctioned subject; assigning a random bidder ID by the server to each of the at least one sealed bids received from at least one bidder computing device during the time duration of the auction; creating a data record for each of the at least one sealed bids and storing the data record in the server, the data record containing at least one random bidder ID, at least one actual bidder ID, at least one timestamp and at least one bid amount; and determining by the server the winning bid at the end of the time duration of the auction according to the data record for each of the at least one sealed bids. Price references will be provided for historical auctions and transactions within the system.

The foregoing discussion of the preferred embodiments has been provided only by way of introduction. Nothing in this section should be taken as a limitation of the claims, which define the scope of the invention.

### BRIEF DESCRIPTION OF THE DRAWINGS

FIG. 1A depicts a system architecture according to exemplary embodiments of the present invention;

FIG. 1B depicts the database according to exemplary embodiments of the present invention;

FIG. 2 depicts a data record according to exemplary embodiments of the present invention;

FIG. 3 depicts a computing device according to exemplary embodiments of the present invention;

FIG. 4 depicts a computing device according to exemplary embodiments of the present invention;

FIG. 5A depicts the bidding process, from the bidder's side according to exemplary embodiments of the present invention;

FIG. 5B depicts the continuation of the bidding process from the bidder's side according to exemplary embodiments of the present invention.

FIG. 5C depicts the process of distribution of the “price-protection fee” according to exemplary embodiments of the present invention;

FIG. 6A depicts the bidding process from the vendor's side according to exemplary embodiments of the present invention;

FIG. 6B depicts a continuation of the bidding process from the vendor's side according to exemplary embodiments of the present invention;

FIG. 6C depicts a continuation of the bidding process from the vendor's side according to exemplary embodiments of the present invention; and

FIG. 7 depicts the process of determining the winning bidder when there are more than one identical highest winning bid amounts.

### DETAILED DESCRIPTION

Traditional auctions, as known in the prior art, imply transfer of ownership of the auctioned item. The present invention includes but is not limited to traditional auctions, where goods are sold from one party to another together with the ownership rights. Exemplary embodiments of the current invention not only allow the ownership of auction properties to be transferred, but also allow the transferring of the possession rights for auctioned subject from one party to another without transferring actual ownership. Transferring of the possession rights may or may not include transferring of ownership.

Possession rights over a property is the control that a person exercises over a property of value and transferring of the possession rights requires an intention of the other party to possess that property of value in exchange for monetary value. Sharing occurs in cases without transfer of ownership. Sharing can take a variety of forms, including but only limited to provide individuals, business entities, non-profit organizations or government agents with the optimization of resources through the redistribution, sharing and reuse of excess capacity in goods, spaces, services, etc.

Also known as the sharing economy business, the Collaborative Economy Business (CEB), includes but is not limited to sharing, lending, and renting, etc. Generally, the CEB can be categorized as sharing goods, sharing skills (i.e. professional or personal service skills), sharing spaces (i.e. sharing residential or office space), and sharing services, such as sharing of transportation (i.e. sharing car service), sharing financial resources (i.e. money lending) and sharing other items that are completely different from the above categories, if any, for auctions. Exemplary embodiments of the present invention provide a platform for sharing of any of the above resources that may have monetary value. Since sharing of resources implies a level of personal interaction at some points, the bidders may be subject to pre-approval by vendors before they can submit their bids and before the auction begins.

In sharing goods, a vendor may be able to list a property of value for auction that may be in high demand and solicit bids from bidders who may have a need for sharing such goods. As sharing occurs without the transfer of ownership which may imply some risks, there may be a pre-approval procedure of bidders. Consequently, the winning bidder and vendor can come to an agreement through the method and system disclosed herein in the auction on the amount of the payment for sharing. Winning bidders may frequently recycle the usage of the property of value through exemplary embodiments of the present invention.

In sharing skills, vendors may provide individuals with certain expertise or a certain set of skills that may become in high demand by bidders when resources are low. Depending on the demand, bidders may submit bids to win the desired skills the vendor may possess. Details of the sharing, such as, for example, bidders' eligibility, may be subject of pre-approval by vendors. Consequently, the winning bidder and vendor can come to an agreement through the method and system disclosed herein in the auction on the amount of the payment and for sharing. For example, a talented and popular singer whose singing skills are in high demand could auction his/her skills to perform at the private party or special events. The bidder who offers the highest bid amount compared to other bidders, would win the auction and enjoy the singer's performance at their parties, for example, Christmas or New Years.

In sharing spaces, a vendor may be able to list a space in which the vendor has the rights to possess but does not necessarily own the space. Vendors are able to solicit bids from bidders who may have a need to rent out or sub-lease the space at a certain location for a certain period of time. The winning bidder and vendor can come to an agreement through the method and system disclosed herein in the auction on the amount of the payment and for sharing. For example, in a holiday season when some of the hotel rooms are in high demand by visitors, hotels may auction their available inventory. That would not only allow the hotels to sell their rooms, but also obtain best possible prices since there would be many people looking for accommodation during holidays or special events, for example, Soccer World Cup. This method would be mutually beneficial for vendors and bidders, as vendors would obtain best possible price for their available space and bidders would be given opportunities to get the desired space, as long as they can offer the highest price for it.

In sharing services, there are different categories depending on the type of service. Consequently, the winning bidder and vendor can come to an agreement through the method and system disclosed herein in the auction on the amount of the payment and for sharing. For example, for sharing transportation, a vendor may list a ride sharing proposal with details of such proposal within an auction, for example, to share a ride with a bidder from point A to point B at a specific time. The bidders may be subject of pre-approval by vendor before participation in the auction. Bidders who are interested in sharing the ride submit their bids for the price they would like to pay.

For sharing financial resources, for example a vendor who is interested in lending money may list in an auction the details for a loan, including a certain amount of money with a certain duration. Bidders who are interested in loaning money may be subject to be pre-approved by the vendor before they bid. They may be able to bid to obtain the loan if the winning bidder can afford higher interest rate than others. And the winning bidder and vendor can come to an agreement through the method and system disclosed herein for the loan interest, etc. in the auction.

The present invention further provides a system for online sealed bid auctions, mitigation of risks related to online auctions and optimization of vendor-bidder benefits. Bidders and vendors herein may include, but are not limited to various types of users such as individuals, business entities, not for-profit organizations or government agents or, etc. The system integrates a means for maintaining one or more of the databases, wherein such databases include but are not limited to vendor's and bidder's information without disclosing bidders' real IDs, information about auctioned tangible and/or intangible auctioned subject, and the database of successful transactions within specific period of time. The database serves as a reference point to potential bidders and vendors about the price of the previously auctioned subject, especially when the bidders and vendors lack adequate knowledge and experience.

Users of the system who want to participate in online auctions may register for an account with the system, which includes a user agreement with the relevant rules as preset for both vendors and bidders prior to the start of the auction. Registering an account includes personally identifiable information as well as valid financial information. This may include, but is not limited to, name, address, email, phone number, and valid financial information. User accounts will be verified by the system through email or phone. Exemplary embodiments of the system will only allow users to register one account by email and/or phone number with a username. Such account can be used to bid or list the auctioned subject for auction. To prevent fraud in creating multiple accounts, the system will require a genuine name, genuine address and genuine financial information in order to register the account. Users of the system may be required to include financial information such as a debit card, credit card, third-party payment systems such as PayPal™ or Square™, and/or bank account details. Financial information is needed to confirm that bidders have enough money in their account to pay the amount of the sealed bid they submit. Verifying payment by confirming the buyer's financial capabilities will avoid default or delayed payments after the auction ends. This avoids issues that include but are not limited to delayed payment, buyers who bid purely for enjoyment, bidders who do not have enough money to pay, and buyers who cancel the transaction by non-payment after the auction ends. The system promotes bidders to submit bids only for amounts they are confirmed to have, thereby preventing the cancellation of transactions and unable to pay after auctions are completed on the basis that the bidding was erroneous, etc.

Exemplary embodiments allow vendors to list auctioned subject offered for auction through an online auction platform. Vendors must register their auctioned subject for the online auction by submitting an introduction about the details of the auctioned subject, which may include but is not limited to written descriptions, photos, videos, etc. Any deficiencies must also be disclosed to avoid misrepresentations or fraud. The vendor's ID or username will be disclosed with the auction listing and will be disclosed when providing feedback after the transaction is completed at the end of the auction. Before the property that is auctioned is officially listed in the online auction platform, the system will issue an index number for each auction subject that is listed and will also issue a timestamp for the start time of the auction. The system will track the auction until the end of the time duration of the auction as preset by the vendor. The vendor must provide double confirmation by confirming that the auction subject is ready to be delivered or performed once the auction concludes and proper payment is made, for example, if the auctioned items are goods, they will be delivered to the winning bidder, unless there are special circumstances beyond vendor's control, such as natural disasters, war, etc. In addition to that the vendor must confirm that the starting or reserve price he/she sets for the auctioned subject is indeed the price he/she is willing to accept as a starting or reserve price. This prevents a vendor from cancelling the transaction after the auction ends by making excuses where the vendor cannot locate the property or claiming that he/she made a mistake while setting a starting or reserve price. If a vendor confirms with the system but subsequently cancels the transaction after the auction ends, then the vendor's account may be suspended for a certain period, for example one month for the first time or the vendor's account may be suspended permanently if it occurs a second time, excluding certain circumstances and force majeure.

When bidding, normally visible aspects of the auction, for example, the bidder's username and other bidder-identifying information will not be shown. Instead, bidders will be listed in the order they bid using randomly generated ID numbers by the system, which will not be accessible to other bidders except bidders themselves even after the auction is finished. Once the auction is finished, only the vendor will be able to see the real ID of the winning bidder. Other bidders will only be able to see the bid amounts of other bidders without seeing their real IDs. The bidding times for each sealed bid will have a timestamp which is displayed to track the bids in the auction. Users will be able to see the applicable remaining time left for the auction regardless of where the user is located. A randomly generated numbers matched to each bidder that is unidentifiable eliminates the public disclosure of bidders' identities and the chance for others to potentially emotionally bid on the auction based on past interactions with the same bidders. Emotional bidding can lead to skewed prices that do not reflect real value. In addition to that, random bidder IDs may prevent or reduce “shill bidding”, “collusion”, etc. as it will be impossible to identify bidders, their previous bidding activities and interests based on their IDs. Vendors will not be able to see identities of bidders and as such manipulate the winning price by asking friends or relatives etc. to submit unreal bids to inflate the price of the auctioned item before the end of the auction.

The bidding process for sealed bids within the auction allows for honesty and integrity when listing for auction or submitting bids. Vendors will need to disclose their usernames and be known to potential bidders. Additionally, emotional bidding or indecent bidders who often shill bid, etc. will be taken away because bidders are not identifiable when using randomly generated ID numbers. However, the system will still allow a vendor to block a particular ID number from bidding if the vendor chooses to do so because that particular bidder was causing problems in previous transactions. When the vendor indicates an ID number they would like to block, the system will be able to match the ID number with the respective bidder and block the bidder from bidding within that auction.

In addition to confidential real ID numbers, the sealed bids will not show the bid amounts to other bidders during the auction and before the end of the auction. Bidders may then bid a realistic amount that reflects their expectations and only an amount they have the capability to pay. Bidders must provide double confirmation by verifying the bid amount is accurate and after submitting their bid amount they need to verify the capability of paying the bid amount with any applicable shipping costs, insurance, etc. Therefore, there will be no discrepancies or argument that the bidder made a mistake on the amount when bidding. This method of receiving confirmation is necessary to provide some risk to indecent bidders, which may include any or all of the above indecent bidders described above, because there will be a potential cost involved with bidding without the intent to actually pay. There is integrity built into the system as bidders are required to pay the sealed winning bid amount within a certain amount of time after the auction ends. Indecent bidders such as shill bidders who often shill bid, etc. will be substantially reduced because exemplary embodiments of the present invention will make it hard to revoke the winning bid after the confirmation has been obtained from the bidder. By incorporating the risk of losing the money through the applicable fees associated with bidding, indecent bidders will be deterred from bidding. The higher the price the indecent bidder bids, the higher the chance to win and therefore the higher the costs this indecent bidder will incur, if he or she happens to be a winning bidder.

If the winning bidders fail to pay the winning bid amounts within the pre-determined time, the system will suspend their accounts indefinitely as payment cannot be made, unless the vendor and/or administrator of the system allows otherwise. After the auction ends, the transaction must be completed within a certain amount of time, for example, within ten days of the auction ending. If the transaction is not completed within the certain time, except certain circumstances and force majeure, the system may suspend the defaulted party for a certain period of time, for example 30 days for the first incident. If there is a second incident, where the same party defaults to either provide or pay for services or goods, such defaulted party may be suspended permanently. Therefore, there should be no incidents of transactions not being completed timely as both vendors and bidders will have confirmed their respective capabilities for the auction. Once the auction ends and the winning bidder is determined, the winning bid price along with all the other submitted bid amounts will be revealed to all bidders.

Exemplary embodiments of the present invention allow bidders to have only one valid bid amount, which however could be changed by adding more, lowering the amount of the bid and then re-submitting the bid again before the end if the auction. Additionally, bidders may withdraw their bid before the auction ends. Furthermore, withdrawn and/or changed bids will still remain sealed so others will not be aware of the withdrawn or changed bidding IDs and/or amounts. By keeping withdrawn or changed bids confidential the system prevents the bidders to use these withdrawn and changed bids as reference and also can eliminate misrepresentation or fraud. Exemplary embodiments of the present invention allow vendors to contemplate the real value they expect to receive from the proceeds of the auction and list the price they honestly believe auctioned subject is worth. This results in encouraging those users who are bona fide and have the capability to pay the amount to submit sealed bids and possibly win the auction without being concerned with being cheated.

Therefore, exemplary embodiments of the present invention can substantially prevent “bid shilling”, “bid shielding”, “bid sniping” and “collusion”, etc. because nobody knows who are the bidders, who is the highest bidder and what are the bid amounts during the auction, or the one who bids at the last second will not necessarily be the actual winning bidder at the end of the auction.

In the prior art, it is common for the auctions to have a reserve price. A reserve price is a hidden minimum price that the vendor is willing to accept for a property. In a reserve price auction, the vendor is only obligated to sell the property once the bid amount meets or exceeds the reserve price. The downside of this concept is that the bidders don't see the hidden price and are left to constantly speculate about the amount of the hidden reserve price, which oftentimes results in a failed auction as the bidders cannot reach the reserve price because they bid too low. Exemplary embodiment of the present invention differentiates from the prior art in a way that it allows the vendors to either set an open reserve price or a conditional hidden reserve price, at the vendor's discretion. The open reserve price is the minimum price the vendor will accept in order for the auction to be successful, which will be disclosed to the bidders. When the vendor chooses to set an open reserve price, he open reserve price would be disclosed to the bidders prior the start of the auction to make the bidders aware of the minimum price accepted by the vendor. All bids below the open reserve price would be rejected by the system. The open reserve price would not allow for premature termination unless a pre-determined set of circumstances warrant the premature termination, as bidders are aware of the minimum reserve price since it is open, and can only submit bids that equal or exceed the reserve price preset by the vendor. In accordance to the exemplary embodiments of the present invention conditional hidden reserve price is: first, the system allows the vendor to terminate the auction early or continue until the end of the auction if one of the bidders reaches or exceeds the reserve price set by the vendor. Second, the system would allow for the bids to be accepted even if the bids don't reach the conditional hidden price set by the vendor and the highest submitted bid amount would be considered a winning bid. This method of providing two categories for reserve prices is more efficient and transparent than the prior art because it allows auctions to still be completed successfully thereby reducing the chances for the auction to fail due to bidders' speculated bid amounts that don't reach undisclosed hidden reserve price set by the vendor.

In addition, sealed-second price method with or without the one bid increment increase that is used by prior art is deficient because it may deprive all other bona fide bidders from winning as the winning bidder may potentially submit an artificially high bid amount to win the auction. In prior art, sealed second-highest bid amount has been established as a base value that the winning bidder pays. The highest sealed price may be one bid increment more than the second-highest sealed bidder's bid amount. One bid increment is the amount by which the current highest bid must be raised by the bidder to win the auction. Bid increment is a pre-determined amount prescribed by the rules of the auction where the auction has a preset table of bid increments depending on the property's beginning or current price in the auction, such as $0.5, $1, $5, or $10. However, one bid increment approach is not effective because the final winning amount to be paid is often times not substantially related to the final winning bid amount. The fact that the winner may only have to pay one increment value more than the second-highest winning price, may induce indecent bidders to place artificially high bid amounts with the sole purpose of winning the auction. Such indecent bidders do not have to take responsibility for paying the amounts they bid and therefore do not fear facing financial consequences of their artificially high bid amounts. The embodiment of the present invention intends to resolve this deficiency. According to the embodiment of the present invention the winning bidder is responsible for paying either the full amount of the winning bid or a certain percentage of the winning bid plus the amount of the second-highest bid. Since the winning bid amount is directly related to the amount the winner pays, the bidders are less likely to place artificially high bids.

Exemplary embodiments of the present invention provide a method through computing system to divide the bidders into two categories, such as a bidding category one bidder and a bidding category two bidder, wherein a bidding category one winning bidder is required to pay the submitted sealed bid amount and wherein a bidding category two bidder is committed to buy a “price-protection policy” to have a chance of reducing the final winning bid amount. The bidder should self-determine or classify himself/herself either as a bidding category one or a bidding category two bidder based on his/her own experience, preference, in consideration of the auction strategies or as randomly chosen by the bidder. Based on two categories, the name of the bidding category can be flexible, such as bidding category A and B, “experienced” and “inexperienced” or any other names to identify two different categories of bidders. Exemplary embodiments of the present invention divide the bidders into bidding category one and bidding category two bidders: A bidding category one bidder will be responsible for the winning bid amount, while bidding category two bidder may be able under certain conditions to enjoy the potential benefit of paying the reduced price with the purchase of the “price-protection policy”. Exemplary embodiments may offer a “price-protection policy” at a certain percentage of the submitted bid amount (e.g. 3% or 5%) for bidding to potentially lower the winning bid amount if the bidder indicates he or she is a bidding category two bidder. The bidders will have a chance to change categories they belong to while bidding in different auctions. A bidder, who confirms to be a bidding category one bidder when bidding for one auctioned subject, may identify himself/herself as a bidding category two bidder during the auction or when bidding for another auctioned subject in another auction. Accordingly, a bidding category one bidder who confirms the bid amount based on his/her own experience, preference or in consideration of auction strategies or as randomly chosen by the bidder should bid with confidence and have no regrets about the payment obligations if he/she is the winning bidder after the auction ends. Similarly, a bidding category two bidder who commits to pay the “price-protection fee” may feel comfortable bidding with the possibility of obtaining a potential discount if he/she is the winning bidder after the auction ends.

Exemplary embodiments of the present invention will resolve the deficiencies described above, for example, “winner's remorse”, by using a “price-protection policy” and “price-protection formula”. According to exemplary embodiments of the present invention, the winning final price paid by a bidding category two winning bidder is calculated by the sum of: the “price-protection fee”, the second-highest bid amount, and the amount from a pre-determined percentage of the difference of the winning bid amount and the second-highest bid amount. Bidders will have to confirm which bidding category they belong to before they start to bid and may change their bidding category before the end of the auction. The bidder will then be responsible for the amount of bid they submitted according to the bidding category they belong to. Bidding category one bidders will be responsible for the full submitted bid amount, whereas bidding category two bidders will have a chance for paying a reduced amount of the winning bid due to the “price-protection policy”. The final amount of the winning bid may be recalculated according to the “price-protection formula”, where the winning final price paid by a bidding category two winning bidder is calculated by the sum of: the “price-protection fee”, the second-highest bid amount, and the amount from a pre-determined percentage of the difference of the winning bid amount and the second-highest bid amount. Depending on different business strategies, the system may provide the option for vendors to determine who will be awarded the fee for “price-protection policy”. As preset by the vendor through the system, the fee paid for the “price-protection policy” may be entirely awarded to the vendor, entirely awarded to second-highest bidders wherein the “price-protection policy” fee amount is split between all second-highest bidders by the pre-determined percentage, or it may be split by the pre-determined percentage between the vendor and second-highest bidder(s). As a practical matter, if the vendor is confident that the auctioned subject will attract many bidders, he/she may choose to keep the entire amount of the “price-protection fee”. On the other hand, if the vendor wants to attract more bidders to participate in the auction for the auctioned subject, he/she may decide to award the entire “price-protection fee” to second-highest bidder(s). Therefore, even if the vendor receives less than the original winning bid because the bidder purchased the policy, the vendor will still have an option to receive a portion of the “price-protection fee” payment in addition to the recalculated winning bid amount. Additionally, the bidding category two bidders may bid without having to worry about overpaying for the auctioned subject, which will ultimately promote participation in the auction. In addition, if there is only one bidder placing the bid for the auctioned subject and the bidder identifies himself/herself as a bidding category two bidder, the entire amount of the “price-protection fee” goes to the vendor and the starting price of the vendor is considered as the second-highest bid amount.

However, there is an element of risk involved in purchasing the “price-protection policy”. Purchasing the “price-protection policy” will not always lower the winning bid amount the bidder pays. If there is a high difference between the winning bid amount and the second-highest bid amount, then a bidding category two bidder buying the policy will likely have their bid amount substantially lowered. However, if there is a small or nominal difference between the winning bid amount and the second-highest bid amount, then a bidding category two bidder buying the policy may end up incurring more costs or a loss because the final price the winning bidder will pay will be higher than their originally submitted bid amount. This potential loss associated with the “price-protection policy” purchase will prevent the bidders from abusing the system. If there was no potential loss involved, it would make the method of “price-protection policy” meaningless because every bidder would be buying a “price-protection policy” to reduce the winning bid amount and pay less, which will substantially undermine one of the business principles that business should be at risk.

To illustrate the method that there exists potential risk for purchasing the “price-protection policy”, three examples are provided herein: Example One. A bidder, for example, Bidder 1, confirms he/she is a bidding category two bidder, submits a bid of $100 and pays a “price-protection fee”, which may be 5% of the $100 (i.e. $5.00). The pre-determined percentage applicable to the winning bid is indicated as 20% for the difference between the winning price and second-highest bid amount, for example. Another bidder, for example Bidder 2, confirms he/she is a bidding category one bidder and submits a bid of $50, which is the second-highest bid amount. Yet another bidder, for example Bidder 3, confirms he/she is a bidding category one bidder, submits a bid of $40. At the end of the auction, Bidder 1 is the winning bidder and the winning bid amount is calculated according to the above formula of the method where Bidder 1 pays: second-highest bid amount+[20%*(winning bid amount-second-highest bid amount)]. Therefore, Bidder 1 ends up paying: $50+[20%*($100−$50)], which is $60. Bidder 1's total cost for the auctioned item is now the $60 final price and the $5.00 “price-protection fee”, which is a grand total of $65. Bidder 1 basically pays a total of $65 when Bidder 1 originally submitted a bid for $100, therefore saving $35. Bidder 3 ends up not winning and therefore no policy fees will be deducted from his/her account.

Example Two. Assume the same situation above applies for this example, except Bidder 1 bids $101 and pays the $5.05 “price-protection fee”. Bidder 2 bids $100, which is the second-highest bid amount. Bidder 1, who is the winning bidder at the end of the auction will pay: $100+[20%*($101−$100)], which is $100.20. Bidder 1's total cost for the auctioned subject is now the $100.20 and the $5.05 “price-protection fee”, which is a final grand total of $105.25. Bidder 1 this time pays $4.25 more than the $101 bid that Bidder 1 originally submitted, therefore suffering the loss because of purchasing the “price-protection policy”.

Example Three. Assume yet again the same situation in Example One, where Bidder 1 bids $100 and pays the $5.00 “price-protection fee”. Bidder 2 bids $80. Bidders 1, who is the winning bidder at the end of the auction will pay: $80+[20%*($100−$80)], which is $84. Bidder 1's total costs for the auctioned subject is now the $84 and the $5.00 “price-protection fee”, which is a final grand total of $89. Bidder 1 this time saves $11 but does not receive a significantly lower amount compared to Example One.

Therefore, exemplary embodiments of the present invention prevent the bidders who may bid artificially high amounts in order to win the auction without paying for the price that he/she bids because the present invention requires the bidder to pay full amount they bid or uses a certain pre-determined percentage between the winning amount and the second-highest bid amount. Bidders will be deterred from bidding artificially high and be prevented from overbidding because the higher the bid amount, the more money the bidder will have to pay in the end. Exemplary embodiments of the present invention will reflect a more realistic value of what the winning bidder should pay and also deter bidders from making artificial sealed bid amounts. Bidders who win will also be less likely to state they think they overpaid for the item if they are categorized as a bidding category one bidder, because the bidders will have an option to bid as a bidding category two bidders and have the final win amount recalculated, which may result in a potential discount. Thus, the “winner's curse” may be substantially reduced as a result.

To potentially reduce multiple bids with the same amounts, the bids may be required to be submitted in dollar amounts with two decimal spaces after the dollar amount (e.g. $25.78).

In the event that the two highest bidders who bid the same price are of the same bidding category (e.g. either two bidding category one bidders or two bidding category two bidders), then the bidders may re-bid again within specific period of time pre-determined by the system. However, if the two highest bidders who bid the same price are of two different categories (e.g. one is a bidding category one bidder and the other bidder is a bidding category two bidder), then the final price for both bidders may be calculated and the bidder with the highest final price may be determined to be the winning bidder in this situation. Determining the winning bidder based on the highest final price in this situation will preserve fairness in that the person paying the most will be the winning bidder.

After a bidder and a vendor complete a transaction, it is helpful for both parties to provide feedback to each other to better improve the auction services. Usually, this is done through ratings and/or comments. After the auction ends and both sides complete the transaction through payment and delivery of the auctioned subject, if applicable. Exemplary embodiments of the system will allow vendors and bidders to rate each other and provide feedback related to the transaction. The system will provide the opportunity for both parties to contact each other prior to submitting negative ratings/reviews. This will provide for better communication between the parties and opportunity to solve any problems and concerns and decrease the chances of negative reviews.

Notifications may be sent by the system through the server to both vendor computing devices and/or bidder computing devices through emails, instant messages, voice messages, etc. when necessary to alert them of different occurrences, including but not limited of a successfully submitted bid, relevant time duration for the auction, rejected bids, auction wins, auction results, etc.

The above system is used to provide a platform to facilitate at least one or multi-sided matching auction markets, where bidders may simultaneously bid from one or multiple vendors and vendors may solicit to one or multiple bidders, wherein each transaction is facilitated against a fee or commission.

The system also comprises means for determining the costs associated with one or more risk elements of the transaction, wherein the means utilize the bidders' information to identify the highest bid and the second-highest bid amount, the cost of the “price-protection policy” for bidding category two users, as well as the final amount the winning bidder has to pay. In addition to that, the system or the platform may charge a certain percentage of service fees for providing auction services.

The present invention may also utilize a data verification module in online auction. This would verify at least four major data sets through the system: 1) identify bidders and vendors; 2) identify that data submitted to the auction is accurate; 3) verify the winning bidder; and 4) verify completion of transaction, etc.

ID Verification. One of the problems that arise in online auctions is that of information asymmetry due to the fact that transactions are completely anonymous. To resolve the anonymity problem, the system may allow vendors and bidders to become “ID Verified” by paying a small fee to have their identity confirmed by a credit information company. Doing so may reassure the users that their counterparties, bidders and vendors, are verified since their identity is known, and there is more assurance that the users could be tracked down should a problem arise. Verification that Data Submitted to Auction is Correct. Receipt and Safeguarding of Bids. All bids received before the time set for the opening of bids are kept secure. The bids are not opened or viewed by seller or administrator and remain in restricted-access electronic bid box. If the bid was withdrawn, it remains in the bid box until the auction is finished. Before the bids are opened, information concerning the identity and number of bids received is made available only to the administrator of the auction. Opening of bids. The bid opening time is preset by the vendor before the auction. The system verifies the accuracy of the bids. All bids shall be submitted in acceptable numerical format. The bids are verified by the system in the manner that precludes the possibility of a substitution, addition, deletion, or alteration in the bids. Recording of bids. All bids are completed and certified as to its accuracy by the bid system as soon after bid verification is complete. Where bid items are too numerous to warrant complete recording of all bids, abstract entries for individual bids may be limited to item numbers and bid prices. Bids shall be available for viewing wherein the real IDs of the bidders are coded/encoded. Rejection of bids. After bids have been opened, award is made to that responsible bidder who submitted the highest responsive bid according to exemplary embodiments of the present invention, unless there is a compelling reason to reject all bids and cancel the auction. Every effort shall be made to anticipate changes before the opening of the auction and to notify all prospective bidders of any resulting modification or cancellation of the auctioned item. This will permit bidders to change or withdraw their bids and prevent unnecessary exposure of bid prices. As a general rule, after the opening of bids, an auction should not be cancelled and re-solicited. Award should be made on the initial bid invitation for bids and the additional quantity should be treated as a new acquisition. Invitations for bid may be cancelled and all bids rejected before award but after opening when, it has been determined that—(1) Specifications have been revised; (2) The auctioned subject of value no longer available due to circumstances beyond vendor's control; (3) No bids have been received; (4) For other reasons, cancellation is clearly in the public's interest. Verification of completion of transaction. The winning bidder and the vendor would have to confirm that transaction was successfully completed by both parties: 1) The vendor received the payment for the auctioned subject 2) The bidder received the auctioned subject.

Should administrative difficulties be encountered after bid opening that may delay award beyond bidders' acceptance periods. Notice to bidders of rejection of all bids. When the system determines the necessity to reject all bids, the system will notify each bidder that all bids have been rejected and shall state the reason for such action. Receipt of an unreadable electronic bid. If a bid received by the system is unreadable to the degree that conformance to the essential requirements of the bid invitation cannot be ascertained, the system shall notify the bidder that the bid will be rejected due to non-compliance. Mistakes in bids. The system will examine all bids for mistakes and, if any mistakes identified, will notify the bidders to correct the mistakes before their bids can be accepted. Mistakes can include but be not limited to obvious misplacement of a decimal point, etc.

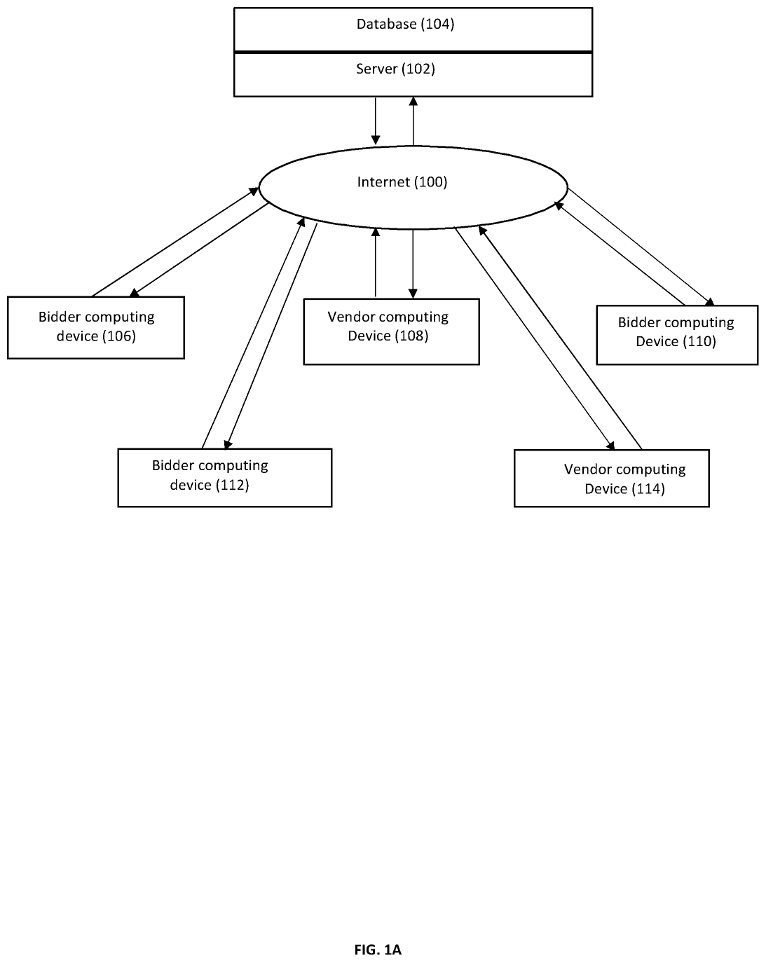

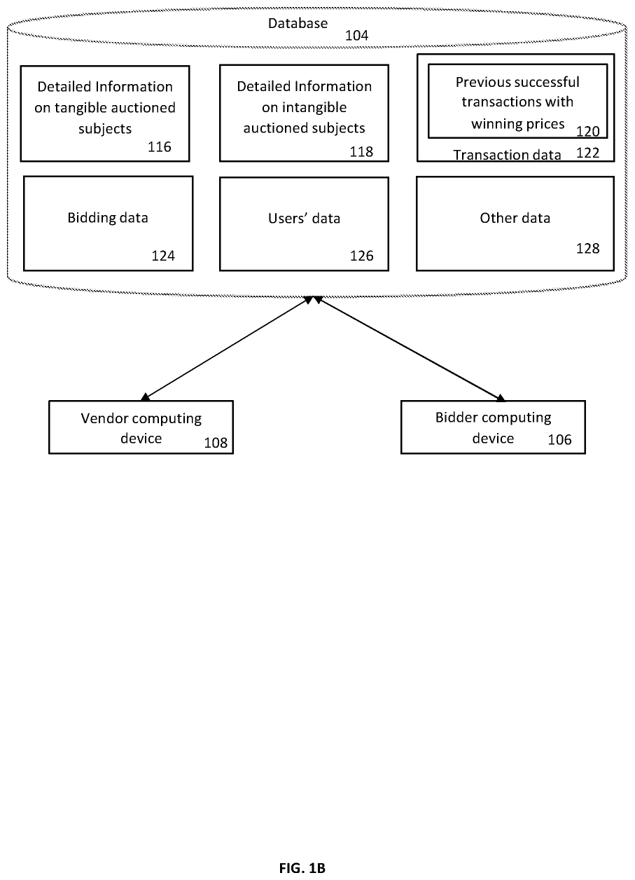

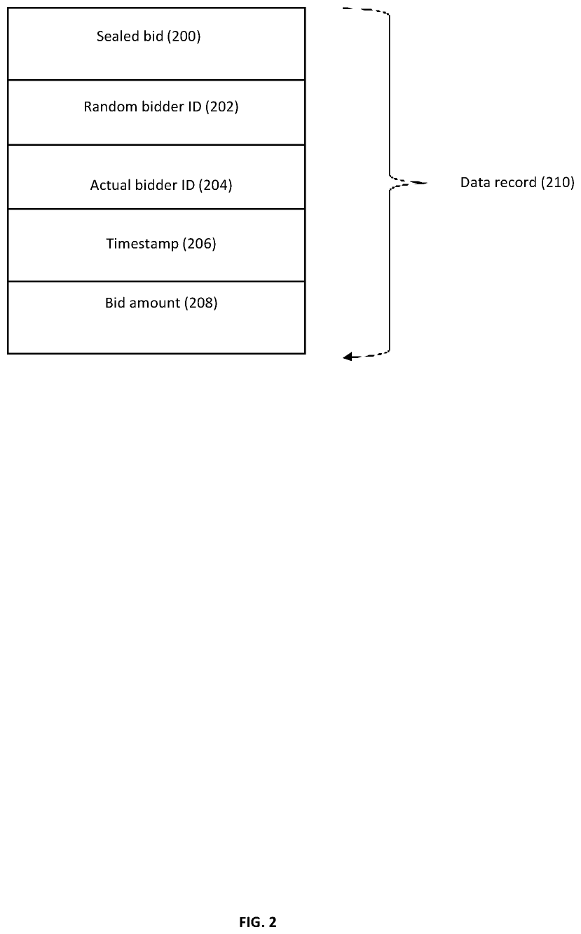

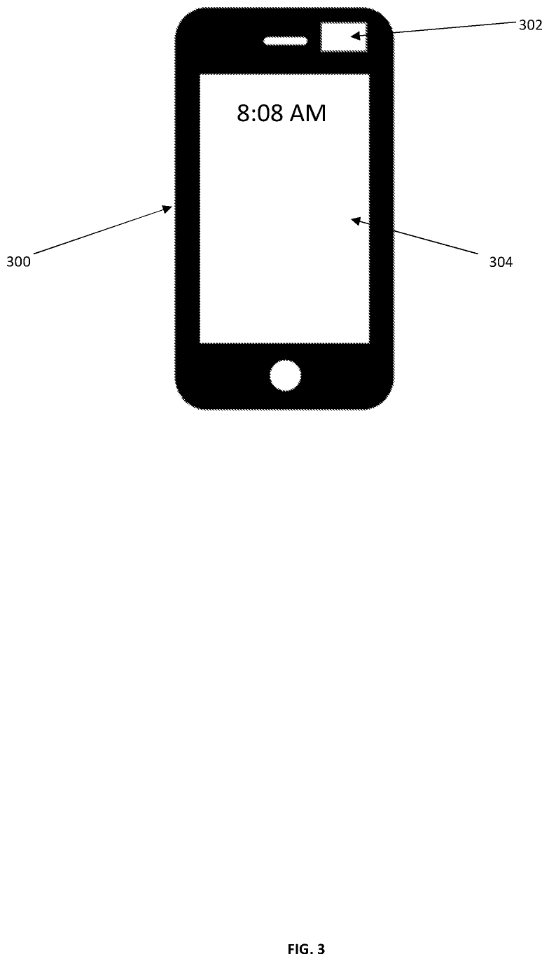

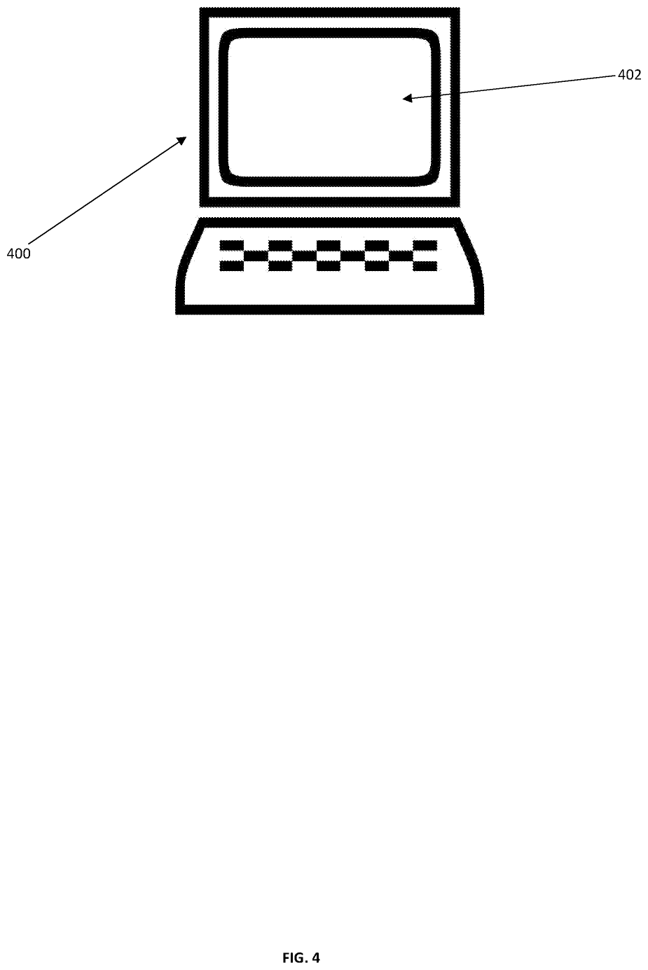

As shown in FIGS. 1A-4, a server (102) in communication with at least one of a plurality of vendors at a vendor computing device (e.g. 108, 114) and at least one of a plurality of registered bidders at a bidder computing device (e.g. 106, 110, 112) through a communication network (e.g. Internet (100)). The server (102) receives an auction request for an auctioned subject from a vendor computing device (e.g. 108, 114), the auction request having at least a description of the auctioned subject and a time duration of the auction input by at least one registered vendor into the vendor computing device and the server presents an auction based on the auction request to the plurality of registered bidders at a bidder computing device (106, 110 and 112); at least one sealed bid (200) may be received in a bidder computing device (e.g. 106, 110, 112) during the time duration of the auction and communicated to the server (102), wherein the at least one sealed bid (200) includes a bid amount for the auctioned subject; a random bidder ID (202) may be assigned by the server (102) to each of the at least one sealed bids (200) received in a bidder computing device (106, 110 and 112) during the time duration of the auction; a data record (210) for each of the at least one sealed bids is stored in the server, the data record (210) containing at least the random bidder ID (202), an actual bidder ID (204), a timestamp (206) and a bid amount (208); wherein the server (102) in communication with at least one of a plurality of registered vendors and at least one of a plurality of registered bidders through a communication network (e.g. Internet (100)) determines the winning bid at the end of the time duration of the auction according to the data record (210) for each of the at least one sealed bids. The server may have a database (104). As shown in FIG. 3, the bidder computing device (300) may have an internal clock mechanism (302) that automatically identifies and communicates to the server (102) the timestamp (206) for each of the at least one sealed bids (200). The timestamp is used to determine the sequence of submitted bids. Each of the bidder computing devices (300) may also have a display (304) and be any computing device known in the art. For example, a smartphone, tablet, personal computer or any other computing device. Similarly, the vendor computing device (400), an example of which is depicted in FIG. 4, may have a display (402) and may be any computing device.

As shown in FIG. 1B, the database (104) contains data related to the bidding process that includes but is not limited to: detailed information on tangible auctioned subjects (116); detailed information on intangible auctioned subjects (118); transaction data (122) which is divided based on the nature of the auctioned subject. The database also contains previous successful transactions with winning prices (120); bidding data (124) (e.g. bid history, prices, timestamps); users' data (126) (e.g. user profiles, financial information, auction history, sealed winning bidder ID information); and other transaction data (128). The database may be connected to and queried by vendors and bidders from a vendor computing device (108) or a bidder computing device (106) to obtain relevant information such as references about historical transactions and prices of the auctioned subjects. The historical transactions within the database may provide a price reference to at least one of the plurality of registered bidders or the plurality of registered vendors about at least one previously auctioned subject of value in case the bidders lack sufficient knowledge and experience about the properties they intend to bid on, or in case the vendors need references for listing reserve prices within auctions. The database can be queried for searches by at least one of the plurality of registered bidders or the plurality of registered vendors about at least one previously auctioned properties of value without disclosing the actual bidder ID of the winning bidders. Each of the at least one sealed bids may be securely stored in the server during the time duration of the auction; at the end of the auction bid amounts and the timestamps are displayed to the plurality of bidders, the actual bidder IDs are not displayed.

The system may have a means for maintaining one or more of the databases, wherein such databases include but are not limited to winning bidders' and vendors' information without disclosed real ID (also referred to as an actual bidder ID), information about auctioned tangible and/or intangible auctioned subjects, and the database of successful transactions within specific period of time.

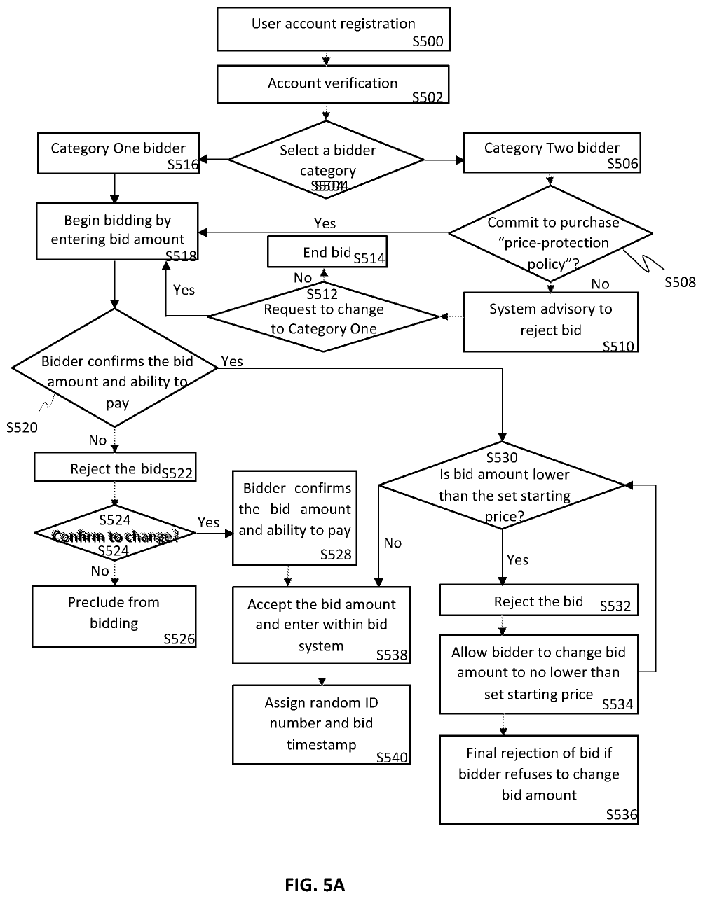

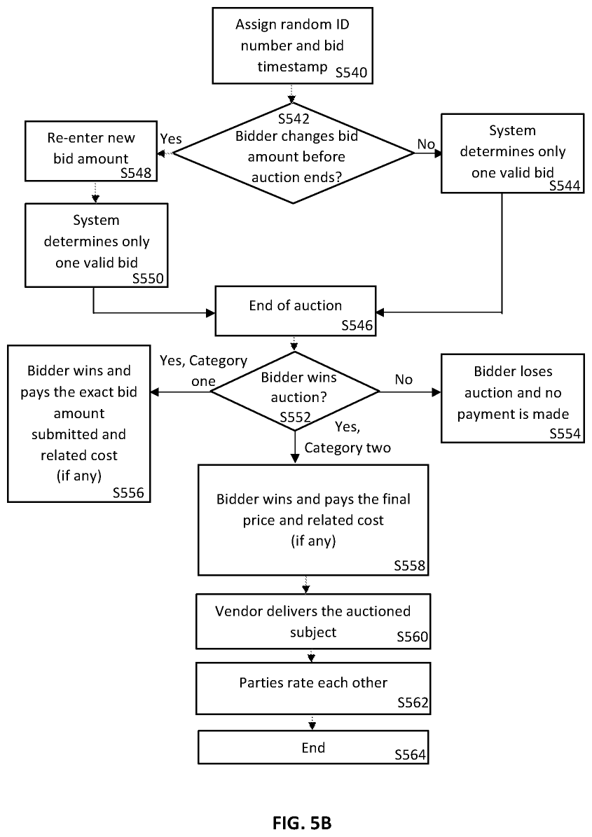

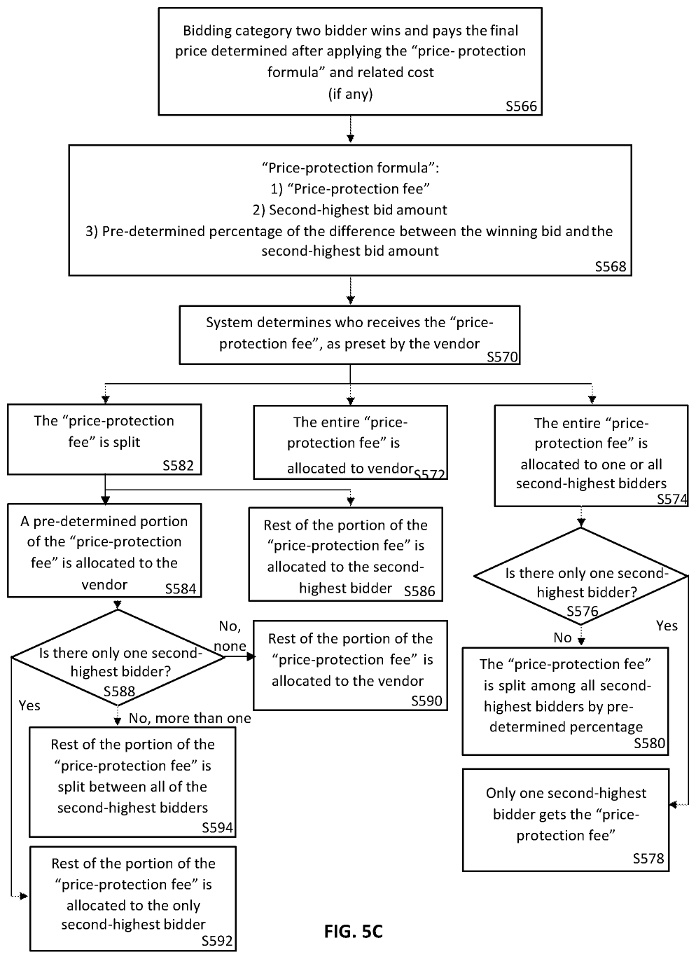

As shown in FIG. 5A, exemplary embodiments of the present invention allow bidders to register with the system (Step S500) before submitting bids for an auction. After the registration, the user account is verified (Step S502) and registered bidders must select a bidding category (Step S504) based on experience, preference, in consideration of auction strategies, or as randomly chosen by the bidder, etc. A bidder who selects to be a bidding category two bidder (Step S506) may commit to pay a fee to purchase the “price-protection policy” for his/her winning bid (Yes, Step S508). If the bidding category two bidder does not commit to pay a fee to purchase the “price-protection policy” (No, Step S508), the system will advise the bidder (Step S510) that the bid will be rejected as a bidding category two bidder. The system will send the bidder with a request to change to be a bidding category one bidder (Step S512). If the bidder chooses yes to change to a bidding category one bidders (Yes, Step S512), then the bidder may begin to bid as a bidding category one bidder on the auction by entering a bid amount to submit to the system (Step S518). If the bidder chooses no (No, Step S508), then the bidder's ability to bid on the auction will end (Step S514).

A bidder who selects to be a bidding category one bidder (Step S516) may begin bidding by entering a bid amount (Step S518). The bidder, regardless if a bidding category one or bidding category two bidder, will then confirm the bid amount is accurate and then also confirm the bidder's financial ability to pay the entered bid amount and affiliated costs, which is the bidder's double confirmation (Step S520). If the bidder does not confirm either the bid amount or the financial ability to pay (No, Step S520), then the bidder will be notified by the system that the bid will be rejected (Step S522). The bidder may choose to change (Yes, Step S524) by confirming the bid amount and financial ability to pay (Step S528). If the bidder still chooses to not confirm the bid amount and financial ability to pay (No, Step S524), then the bidder is precluded from bidding (Step S526). If the bidder confirms the bid amount and the financial ability to pay the submitted bid amount (Step S528), then the bid amount is accepted and entered within the system (Step S538) and assigns a random ID number and bid timestamp (Step S540).

Once the bid is double-confirmed and submitted to the system, the system will query whether the submitted bid amount is lower than the starting price set by the vendor (Step S530). If the bid amount is lower than the starting price set by the vendor (Yes, Step S530), then the system will automatically reject the bid (Step S532) and allow the bidder to change the bid amount to no lower than the starting price set by the vendor (Step S534). If the bidder refuses to change their bid amount, then the system will make a final rejection of the bid (Step S536). After the bidder changes the bid amount, the system will once again query whether the submitted bid amount is lower than the starting price set by the vendor (Step S530). If the submitted bid amount is not lower than the starting price (No, Step S530), then the system will accept the submitted bid amount and enter it for the auction within the bidding system (Step S538) and the bidder's ID will be sealed. Since all accepted bid amounts are sealed, the bidder and bid amount will be assigned a random identification number and a timestamp indicating when the bid was accepted by the system in the auction (Step S540).

As shown in FIG. 5B, after the system assigns random ID number and bid timestamp (Step S540), a bidder is allowed to change the submitted bid amount before the auction ends (Step S542). However, every bidder is allowed to submit only one valid bid. If the bidder does not change their submitted bid (No, Step S542), then the system determines the submitted bid to be the only valid bid (Step S544). If the bidder decides to change their submitted bid (Yes, S542), then the bidder may change the previous bid and re-enter a new bid amount and re-submit again (Step S548). If the bidder does not change the bid anymore, the system will determine the re-entered submitted bid to be the only valid bid (Step S550). Once the time expires on the auction, the auction will end (Step S546).

Once the auction ends, the bid amounts will be opened to the participants of the auction (Step S546), the system will determine if the bidder won the auction. If the bidder wins the auction and is a bidding category one bidder (Yes, category one, Step S552), then the bidder who won will pay the exact bid amount submitted for the auction plus related costs, if any such as shipping fees, etc. (Step S556). If the bidder wins the auction and is a bidding category two bidder (Yes, category two, Step S552), then the bidder who won will pay a final price that is determined after applying the “price-protection formula” plus related costs, if any (Step S558). If the system determines that the bidder did not win (No, Step S552), then the bidder loses the auction and no payment will be made by the bidder (Step S554). After the bidder wins the auction and pays the final price, the vendor delivers the auctioned subject to the winning bidder (Step S560). After the auctioned subject has been delivered to the winning bidder, the parties may rate each other (Step S562). That concludes the transaction (Step 564).

As shown in FIG. 5C, after the bidding category two bidder wins, the final price is determined by applying the “price-protection formula” (Step S566). The “price-protection formula” is calculated by the sum of: the “price-protection fee”, the second-highest bid amount, and the amount from a pre-determined percentage of the difference of the winning bid amount and the second-highest bid amount. (Step S568), then the system determines who will receive the “price-protection fee” (Step S570), which is preset by the vendor. The entire “price-protection fee” may be allocated to the vendor (Step S572) or to the second-highest bidder (Step S574). Then the system further determines the number of second-highest bidders. If there is only one second-highest bidder (Yes, Step S576), then the entire amount of the “price-protection fee” is allocated to the only one second-highest bidder (Step S578). If there are several second-highest bidders (No, Step S576), then the entire amount of the “price-protection fee” is split between all second-highest bidders by a pre-determined percentage (Step S580). Another option is when the “price-protection fee” is split (Step S582) between the vendor and the second-highest bidders by a pre-determined percentage. In this case, one pre-determined portion of the “price-protection fee” is allocated to the vendor (Step S584); the rest of the portion of the “price-protection fee” is allocated to the second-highest bidder (Step S586). In the next step the system further determines if there is only one second-highest bidder (Step S588). If the system determines that there is only one second-highest bidder (Yes, Step S588), then the rest of the portion of the “price-protection fee” is allocated to the only one second-highest bidder (Step S592). If the system determines that there is no second-highest bidder to be awarded (No, none, Step S588) such as in the situation where there is only one bidder and the start price as preset by the vendor will be deemed the second-highest price, the rest of the portion of the “price-protection fee” is allocated to the vendor (Step S590). If there is more than one second-highest bidder (No, more than one, Step S588), then the rest of the portion of the “price-protection fee” is split between all of the second-highest bidders (Step S594) by a pre-determined percentage.

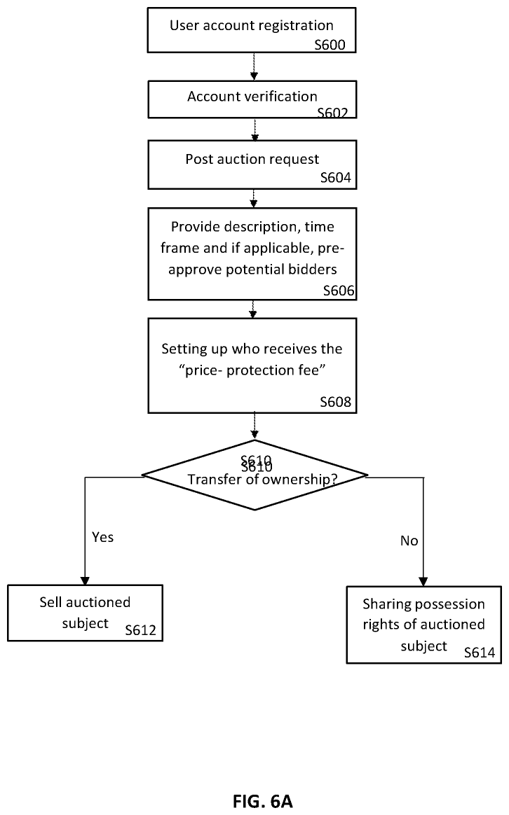

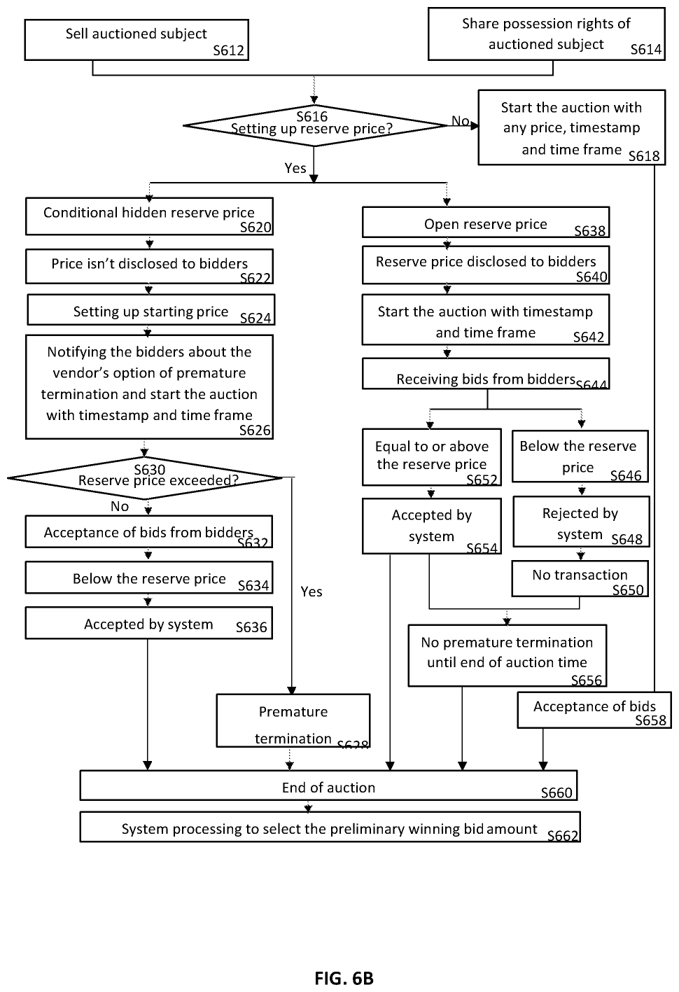

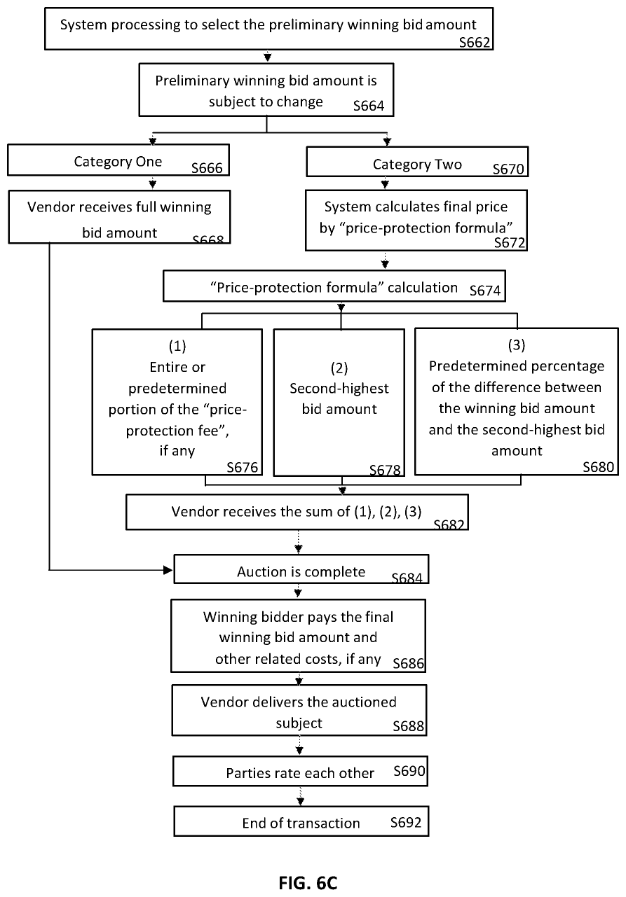

As shown in FIG. 6A, exemplary embodiments of the present invention allow vendors to register (Step S600) an account with the system. Before setting up the details of the auction, the vendor will be subject to verification by the system (Step S602). After verification by the system is complete, the vendor may post an auction request (Step S604). When starting the process of setting up an auction, the vendor may input a description of the property, the time frame for the time duration of the auction, and specify if there are any pre-approved bidders (Step S606). In the next step the vendor decides who receives the “price-protection fee” (Step S608). The vendor may then specify whether the auction involves a transfer of ownership (Step S610). If the auction involves a transfer of ownership (Yes, Step S610), then the vendor intends to sell the auctioned subject at the auction (Step S612). If the auction does not involve a transfer of ownership (No, Step S610), then the vendor intends to share the possession rights for the auctioned subject for a specified period of time at the auction (Step S614).

As shown in FIG. 6B, once the vendor decides if there will be a transfer of ownership, the vendor may set up a reserve price by discretion (Step S616). If the vendor chooses to not set up a reserve price (No, Step S616), then he/she may set up any nominal starting price, such as $1.00, etc., the time frame, including the starting time and the end time of the auction (Step S618). The system will issue a timestamp (Step S618) for such listing with the unique index number to identify different listings. The system will then start to accept bids (Step S658), in which the bid amount cannot be lower than the starting price until the end of the auction (Step S660). After the end of the auction, the system processes all of the bids to select the preliminary winning bid amount by the system (Step S662). On the other hand, if the vendor chooses to set up a reserve price (Yes, Step S616), the vendor may choose between a conditional hidden reserve price (Step S620) or an open reserve price (Step S638). If the vendor chooses the open reserve price option (Step S638), then the system will advise the bidders of the reserve price before the bidders start to bid in the auction (Step S640). The auction begins with the timestamp and the time frame (Step S642) and the system receives bids from bidders (Step S644). If the bids are below the reserve price (Step S646), then the bids are rejected by the system (Step S648) and no transaction occurs (Step S650). If the bids are equal to or above the reserve price (Step S652), then the bids are accepted by the system (Step S654). In both cases the premature termination by the vendor is not allowed (Step S656), unless a predetermined set of circumstances warrant the premature termination. If vendor chooses to set a conditional reserve price (Step S620), then the reserve price is not disclosed to bidders (Step S622). The vendor sets up a starting price (Step S624) and the system will notify the bidders about the possibility of the auction's premature termination by the vendor when auction starts with the time frame and time stamp (Step S626). The system starts accepting bids from the bidders (Step S628). The system will query whether the reserve price was exceeded by the bid amounts (Step S630). If the reserve price was exceeded (Yes, Step S630), then the auction is subject to premature termination as preset by the vendor (Step S628). The system will notify the vendor that the reserve price had been met and the vendor may choose to terminate the auction. The vendor may also set up the system that auction is terminated automatically as soon as the reserve price is met. If the bids do not meet the reserve price, (No, Step S630), the system still accepts such bids from bidders (Step S632) in the system. If the bids are below the reserve price (Step S634), then the system will continue to accept bids from bidders. After the bids are accepted by the system (Step S636) until the auction ends (Step S660), the system processes all the bids to select the preliminary winning bid amount (Step S662).

As shown in FIG. 6C, after the bids are accepted by the system and the auction ends (Step S660), the system selects the preliminary winning bid amount (Step S662). The preliminary winning bid amount is subject to change (Step S664) which may be adjusted depending on the self-determined bidding category. If the winning bidder is a bidding category one bidder (Step S666), then the vendor receives the full winning bid amount (Step S668) and the auction is completed (Step S684). If the winning bidder is a bidding category two bidder (Step S670), then the system calculates the final price by using the “price-protection formula” (Step S672). The “price-protection formula” is calculated (Step S674) as a sum of a pre-determined portion of the “price-protection fee” (Step S676), a second-highest bid amount (Step S678), and a pre-determined percentage of the difference between the winning bid amount and the second-highest bid amount (Step S680). Therefore, the vendor will receive the sum of the above (Step S682). After that the auction is completed (Step S684), the winning bidder pays the final winning bid amount plus any applicable additional costs, if any (Step S686). Vendor delivers the auctioned subject (Step S688), both parties may rate each other (Step S690) and the transaction ends (Step S692).

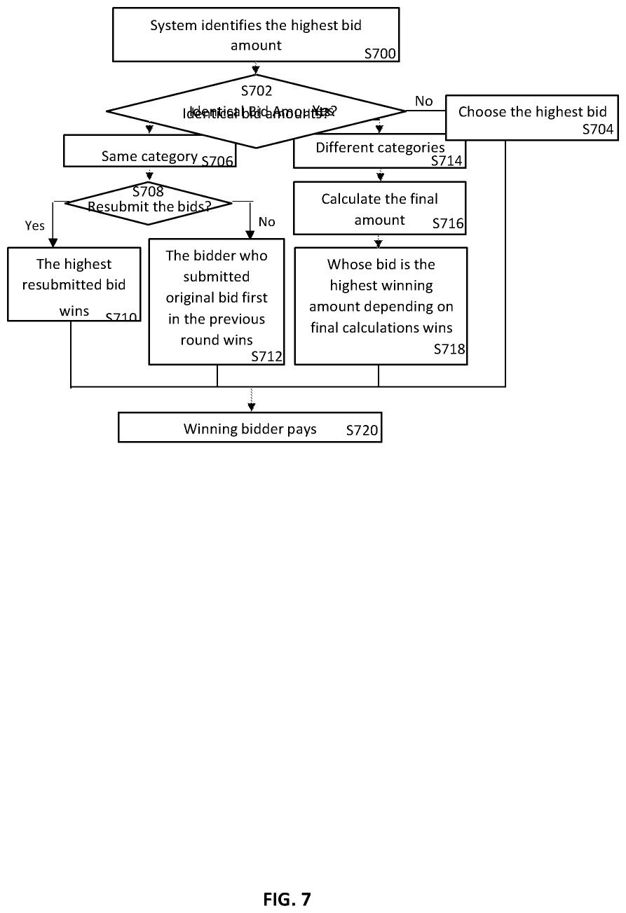

As shown in FIG. 7, after the auction ends, the system will determine the winning bidder with the highest bid amount (S700). The system determines if there are identical bid amounts (S702). If there are no identical bid amounts (No, Step S702), then the system chooses the highest bid (S704). If there are more than one identical bid amounts (Yes, Step S702), then the system determines whether they are same bidding category of bidders (Step S706) or different categories of bidders (Step S714). The term “same bidding category of bidders” means that at least two bidders belong to bidding category one or bidding category two. If identical bid amounts are from bidders of same categories (Step S706), then the system prompts the bidders to re-submit the bids (Step S708) within the pre-determined timeframe. If the bidders re-submit the bids (Yes, Step S708), then the highest re-submitted bid wins (Step S710). If the bidders don't re-submit the bids (No, Step S708) within the pre-determined timeframe, then the bidder who submitted original bid in the previous round first wins (Step S712). If the bidders with identical amounts are from different categories (Step S714), then the system calculates the final amount (Step S716). The bidder whose bid is the highest winning amount depending on final calculation wins (Step S718). Winning bidder pays the final winning amount (Step S720).

The method described herein can be executed on a computing device and/or computer system, generally comprised of a central processing unit (CPU) that is operatively connected to a memory device, data input and output circuitry (10) and computer data network communication circuitry. Computer code executed by the CPU can take data received by the data communication circuitry and store it in the memory device. In addition, the CPU can take data from the I/O circuitry and store it in the memory device. Further, the CPU can take data from a memory device and output it through the 10 circuitry or the data communication circuitry. The data stored in memory may be further recalled from the memory device, further processed or modified by the CPU in the manner described herein and restored in the same memory device or a different memory device operatively connected to the CPU including by means of the data network circuitry. The memory device can be any kind of data storage circuit or magnetic storage or optical device, including a hard disk, optical disk or solid state memory. Examples of well-known computing systems, environments, and/or configurations that may be suitable for use with the invention include, but are not limited to, personal computers, server computers, hand-held, laptop or mobile computer or communications devices such as cell phones and PDA's, multiprocessor systems, microprocessor-based systems, set top boxes, programmable consumer electronics, network PCs, minicomputers, mainframe computers, distributed computing environments that include any of the above systems or devices, and the like.

Computer program logic implementing all or part of the functionality previously described herein may be embodied in various forms, including, but in no way limited to, a source code form, a computer executable form, and various intermediate forms (e.g., forms generated by an assembler, compiler, linker, or locator.) Source code may include a series of computer program instructions implemented in any of various programming languages (e.g., an object code, an assembly language, or a high-level language such as FORTRAN, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The invention may be described in the general context of computer-executable instructions, such as program modules, being executed by a computer. Generally, program modules include routines, programs, objects, components, data structures, etc., that perform particular tasks or implement particular abstract data types. The computer program and data may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed hard disk), an optical memory device (e.g., a CD-ROM or DVD), a PC card (e.g., PCMCIA card), or other memory device. The computer program and data may be fixed in any form in a signal that is transmittable to a computer using any of various communication technologies, including, but in no way limited to, analog technologies, digital technologies, optical technologies, wireless technologies, networking technologies, and internetworking technologies. The computer program and data may be distributed in any form as a removable storage medium with accompanying printed or electronic documentation (e.g., shrink wrapped software or a magnetic tape), preloaded with a computer system (e.g., on system ROM or fixed disk), or distributed from a server or electronic bulletin board over the communication system (e.g., the Internet or World Wide Web.) It is appreciated that any of the software components of the present invention may, if desired, be implemented in ROM (read-only memory) form. The software components may, generally, be implemented in hardware, if desired, using conventional techniques.

The invention may also be practiced in distributed computing environments where tasks are performed by remote processing devices that are linked through a communications network. In a distributed computing environment, program modules may be located in both local and remote computer storage media including memory storage devices. Practitioners of ordinary skill will recognize that the invention may be executed on one or more computer processors that are linked using a data network, including, for example, the Internet. In another embodiment, different steps of the process can be executed by one or more computers and storage devices geographically separated by connected by a data network in a manner so that they operate together to execute the process steps. In one embodiment, a user's computer can run an application that causes the user's computer to transmit a stream of one or more data packets across a data network to a second computer, referred to here as a server. The server, in turn, may be connected to one or more mass data storage devices where the database is stored.

The server can execute a program that receives the transmitted packet and interpret the transmitted data packets in order to extract database query information. The server can then execute the remaining steps of the invention by means of accessing the mass storage devices to derive the desired result of the query. Alternatively, the server can transmit the query information to another computer that is connected to the mass storage devices, and that computer can execute the invention to derive the desired result. The result can then be transmitted back to the user's computer by means of another stream of one or more data packets appropriately addressed to the user's computer.

Exemplary embodiments of the present invention may be also applicable in live auctions where sealed bids may be used in both online and live auctions to maximize the benefits for bidders and vendors. In live auctions, people are physically present or bid by proxy through phone call systems; the auctioneer and/or other related personnel may conduct the process of auctioning a property of value and the bidders may actively participate in bidding. Bidders in a live sealed bid auction may self-determine within two different categories, for example a bidding category one or a bidding category two bidder, prior to submitting their sealed bids. Bidders who are self-determined to be bidding category two bidders may commit to purchase the “price-protection policy” by submitting a check or paying a deposit in a sealed manner, for example, in a sealed envelope. The bidders would be required to submit their sealed bids through a machine that would automatically or manually assign each bidder a random ID number and a clock machine may issue a timestamp. The bidding category would be recorded together with the sealed bid amounts before the submission of the envelopes to the place designated by the vendors or auctioneer's, such as the envelope deposit box. The relevant rules in a live sealed bid auction may be preset for both vendors and bidders prior to the start of the auction.

At the end of auction, the auctioneer and/or other related personnel from the auction organization may calculate the final price and select the winning bidder based on the calculated final prices. The method of “price-protection policy” used for live auctions is identical to the one used in online auctions. The bidders submit sealed bids that are opened at the end of the auction and bidders are not aware about bids submitted by other bidders. Bidders will have to confirm which bidding category they belong to before they start to bid in a live auction and may change their bidding category before the end of the auction. The winning bidder pays the final price according to whether he/she is a bidding category one or bidding category two bidder. Bidding category one bidders will be responsible for the full submitted bid amount, whereas bidding category two bidders will have a chance to recalculate the winning bid amount due to the “price-protection policy”. The final amount of the winning bid may be recalculated according to the “price-protection formula”, which is the sum of a “price-protection fee”, a second-highest bid amount, and a pre-determined percentage of the difference between the winning bid and the second-highest bid amount. Depending on different business strategies, the auction may provide the option for vendors to determine who will be awarded the fee for “price-protection policy” prior to the start of the auction. In live auctions bidders will be notified about who will receive the “price-protection fee” before the auction begins. As a practical matter, knowing that the second-highest bidders may be able to receive the entire or the partial amount of the “price-protection fee” may attract more bidders to participate in live auctions. The winning bidder pays the final price and related costs, such as service fees, taxes, shipping fees, if any, and the vendor will deliver the auctioned subject. The auction transaction is then completed.

The described embodiments of the invention are intended to be exemplary and numerous variations and modifications will be apparent to those skilled in the art. All such variations and modifications are intended to be within the scope of the present invention as defined in the appended claims. Although the present invention has been described and illustrated in detail, it is to be clearly understood that the same is by way of illustration and example only, and is not to be taken by way of limitation. It is appreciated that various features of the invention which are, for clarity, described in the context of separate embodiments may also be provided in combination in a single embodiment. Conversely, various features of the invention which are, for brevity, described in the context of a single embodiment may also be provided separately or in any suitable combination. It is appreciated that the particular embodiment described in the specification is intended only to provide an extremely detailed disclosure of the present invention and is not intended to be limiting.

Modifications of the above disclosed apparatus and methods which fall within the scope of the invention will be readily apparent to those of ordinary skill in the art. Accordingly, while the present invention has been disclosed in connection with exemplary embodiments thereof, it should be understood that other embodiments may fall within the spirit and scope of the invention, as defined by the following claims.

What is claimed is:

1. A computer-implemented system for an online sealed bid auction, comprising:
an auction server in communication with one or more remote computing devices associated with one or more remote bidders via a network, wherein the server includes at least one non-transitory computer-readable storage medium with computer-readable instructions stored therein to remotely perform the online sealed bid auction based on one or more sets of predetermined rules, and a processor instructed to execute the computer-readable instructions to:
transfer for display at least a portion of data related to an auction subject for the online sealed bid auction on the one or more remote computing devices associated with the one or more remote bidders;
receive one or more sets of bid data from the one or more remote computing devices, respectively, wherein each of the one or more sets of bid data comprises a bid amount;
automatically transfer for display, on the one or more remote computing devices, a first representation of the online sealed bid auction comprising one or more different identifiers corresponding to the one or more sets of bid data, respectively;
responsive to a closing time of the online scaled bid auction:
determine a highest bid amount as the winning bid amount for a winning bidder and a second highest bid amount based on the one or more sets of bid data; and
automatically recalculate the winning bid amount for the winning bidder based on at least a portion of data related to the highest bid amount, the second highest bid amount, and at least a portion of committed amount;
transfer for display, on the one or more remote computing devices, a second representation of the online sealed bid auction comprising data related to the winning payment amount or the winning bid amount.

2. The computer-implemented system of claim 1, wherein the processor is further instructed to execute the computer-readable instructions to:
obtain each of the one or more sets of predetermined rules;
define one or more criteria of the one or more sets of predetermined rules corresponding to one or more functions of the system; and
perform the auction remotely based on the one or more sets of predetermined rules.

3. The computer-implemented system of claim 1, wherein the portion of data related to the auction subject comprises at least one of:
a description of the auction subject;
a corresponding auction schedule comprising at least the closing time for the auction;
a starting price for the auction subject; or
the one or more sets of predetermined rules for the auction, wherein the one or more sets of bid data correspond to one or more sealed bids, and at least one bid amount is equal to or higher than the starting price.

4. The computer-implemented system of claim 1, wherein the one or more sets of bid data comprise one or more sealed bids with the one or more respective bid amounts.

5. The computer-implemented system of claim 4, wherein the processor is further instructed to execute the computer-readable instructions to:
recognize, from each of the one or more bidders, only one valid bid and one corresponding bid amount.

6. The computer-implemented system of claim 1, wherein each set of commitment data is indicative of one or more inputs to a respective computing device by a respective bidder to make the commitment.

7. The computer-implemented system of claim 1, wherein the processor is further instructed to execute the computer-readable instructions to:
calculate at least the portion of committed amount based on at least a predetermined percentage of the winning bid amount.

8. The computer-implemented system of claim 1, wherein the winning payment amount is calculated at least by adding the second highest bid amount and a predetermined percentage of a difference between the winning bid amount and the second highest bid amount.

9. The computer-implemented system of claim 1, wherein the processor is further instructed to execute the computer-readable instructions to:
display a portion of data related to the winning payment amount, wherein the winning payment amount is higher or lower than the winning bid amount.

10. The computer-implemented system of claim 1, wherein the processor is further instructed to execute the computer-readable instructions to:
calculate the winning payment amount based on the one or more sets of predetermined rules, wherein the winning payment amount is at least a sum of:
(i) at least the portion of the committed amount associated with the winning bid amount;
(ii) the second highest bid amount of the auction; and
(iii) a predetermined percentage of a difference between the winning bid amount and the second highest bid amount.

11. The computer-implemented system of claim 1, wherein the processor is further instructed to execute the computer-readable instructions to:
responsive to the auction having a sole bidder, use a starting price for the auction subject as the second highest bid amount.

12. The computer-implemented system of claim 1, wherein the additional data is related to allocation of a second portion of the committed amount to a vendor.

13. The computer-implemented system of claim 1, wherein the additional data is related to allocation of an entire amount of the committed amount to the vendor and the one or more bidders.

14. The computer-implemented system of claim 1, wherein the additional data is related to allocation of at least a portion of the committed amount to a bidder of the second highest bid amount.

15. The computer-implemented system of claim 1, further comprising:
processing each set of bid data according to one or more preset rules to determine whether each set of bid data is accepted or rejected;
responsive to a set of bid data being rejected not storing the set of rejected bid data; and
responsive to a set of bid data being accepted, storing the accepted set of bid data on the auction server.

16. A computer-implemented method for an online sealed bid auction, comprising:
transferring for display, on one or more computing devices associated with one or more bidders, respectively, at least a portion of data related to an auction subject for the online sealed bid auction;
receiving, by a server, one or more sets of bid data from the one or more computing devices, respectively, wherein each of the one or more sets of bid data comprises a bid amount;
automatically transferring for display, on the one or more computing devices, a first representation of the online sealed bid auction comprising one or more different identifiers corresponding to the one or more sets of bid data, respectively;
responsive to a closing time of the online sealed bid auction:
determining a highest bid amount as the winning bid amount for a winning bidder and a second highest bid amount based on the one or more sets of bid data; and
automatically re-calculating the winning bid amount for the winning bidder based on at least a portion of data related to the highest bid amount, the second highest bid amount, and at least a portion of commitment amount; and
transferring for display, on the one or more computing devices, a second representation of the auction comprising data related to the winning payment amount or the winning bid amount.

17. The computer-implemented method of claim 16, further comprising:
obtaining each of the one or more sets of predetermined rules;
defining, by the server, one or more criteria of the one or more sets of predetermined rules corresponding to one or more functions; and
performing, by the server, the auction remotely based on the one or more sets of predetermined rules.

18. The computer-implemented method of claim 16, wherein the portion of data related to the auction subject comprises at least one of:
a description of the auction subject;
a corresponding auction schedule comprising at least the closing time for the auction;
a starting price for the auction subject; or
the one or more sets of predetermined rules for the auction, wherein the one or more sets of bid data correspond to one or more sealed bids, and at least one bid amount is equal to or higher than the starting price.

19. The computer-implemented method of claim 16, further comprising:
calculating, by the server, the winning payment amount based on the one or more sets of predetermined rules, wherein the winning payment amount is at least a sum of:
(i) at least the portion of the committed amount associated with the winning bid amount;
(ii) a the second highest bid amount of the auction; and
(iii) a predetermined percentage of a difference between the winning bid amount and the second highest bid amount.

20. The computer-implemented method of claim 16, further comprising:
processing each set of bid data according to one or more preset rules to determine whether each set of bid data is accepted or rejected;
responsive to a set of bid data being rejected not storing the set of rejected bid data; and
responsive to a set of bid data being accepted, storing the accepted set of bid data on the server.
